(19) United States
(12) Patent Application Publication
(10) Pub. No.: US 2010/0287097 A1
(43) Pub. Date: Nov. 11, 2010

(54) Conducting Commercial Transactions with a Mobile Device

(75) Inventor: William S. Treadwell, Richardson, TX (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(73) Assignee: BANK OF AMERICA CORPORATION, Charlotte, NC (US)

(21) Appl. No.: 12/512,078

(22) Filed: Jul. 30, 2009

Related U.S. Application Data
(60) Provisional application No. 61/176,768, filed on May 8, 2009.

(51) Int. Cl. G06Q 40/00

(52) U.S. Cl. 705/42

(57) ABSTRACT

A computer assisted method which includes electronically receiving a request for funds, wherein said request identifies an addressable ID of a mobile device to which the data regarding the funds is to be transmitted. The method also includes creating a funds disbursement, including funds disbursement data. The step of creating a funds disbursement includes deducting from an associated bank account an amount based on the requested funds; generating a one time credit card number associated with the predetermined amount of the funds deducted from the associated bank account; and configuring the funds disbursement data including the one time credit card number, and the name of the particular person to which the funds should be dispersed as a two-dimensional encoded image. The method also includes transmitting the two-dimensional encoded image to the mobile device.

### CROSS REFERENCE TO RELATED APPLICATIONS

This application claims priority benefits based on U.S. Provisional Patent Application No. 61/176,768, filed May 8, 2009. The contents of this prior application are incorporated herein by reference in their entirety.

### BACKGROUND

Conducting commercial transactions usually requires some form of payment (e.g., cash, check, credit card, etc.) when a good has been delivered or the service has been rendered. For example, when a consumer is purchasing goods from a merchant at a point of sale, such as a register, typically the consumer must deliver a payment at the point of sale. However, in some instances, a consumer might not have the payment available at the point of sale. For example, the consumer might not have enough cash, might not have his checkbook with him, may have had a credit card declined, or maybe the consumer's wallet was lost or stolen. Regardless of the reason as to why the consumer does not have a payment available at the point of sale, unless the consumer can deliver some form of payment at the point of sale, it is likely that the consumer will not be able to purchase the good or service at that particular time. Such an occurrence can be inconvenient or embarrassing for a consumer, or in some cases, such as when the consumer is in great need of the good or service at that particular time, such an occurrence can be disastrous.

### SUMMARY

In today's information age, the ability to send and transmit information to handheld electronic mobile devices, such as cell phones, smart phones, pagers, etc. is becoming more prevalent. For example, a large (and seemingly ever increasing) amount of the population owns such a handheld electronic mobile device (hereinafter mobile device). Further, the telecommunications carriers that provide services such as Voice over Internet Protocol (VoIP), Short Messaging Service (SMS), text messaging, e-mail, internet access, etc., to a user's mobile device have greater coverage areas, better quality, and faster speeds than in the past. Additionally, because most people who own such a mobile device usually carry the device with them (especially when they are away from their home or office), the mobile device provides a unique opportunity to provide information to the user regardless of where the user is located. It would be advantageous to be able to leverage the mobile device and its ability to transmit and receive information in order to provide a consumer with the capability to make a payment at a point of sale using information received in the mobile device, e.g., using a visual image or two-dimensional barcode.

Aspects of this disclosure relate to a computer assisted method which includes electronically receiving a request for funds, wherein said request identifies an addressable ID of a mobile device to which the data regarding the funds is to be transmitted. The method may also include creating a funds disbursement, including funds disbursement data. The step of creating a funds disbursement may include deducting from an associated bank account an amount based on the requested funds; generating a one time credit card number associated with the predetermined amount of the funds deducted from the associated bank account; and configuring the funds disbursement data including the one time credit card number, and the name of the particular person to which the funds should be dispersed as a two-dimensional encoded image. The method may also include transmitting the two-dimensional encoded image to the mobile device.

Aspects of this disclosure relate to an apparatus which includes a processor and a memory storing computer executable instructions that, when executed by the processor, configure the apparatus to perform a method of transmitting funds to a mobile device. The method may include electronically receiving a request for funds, wherein said request identifies an addressable ID of a mobile device to which the data regarding the funds is to be transmitted and create a funds disbursement, including funds disbursement data. The method may include creating a funds disbursement may include: deducting from an associated bank account an amount based on the requested funds; generating a one time credit card number associated with the predetermined amount of the funds deducted from the associated bank account and configuring the funds disbursement data including the one time credit card number and the name of the particular person to which the funds should be dispersed as a two-dimensional encoded image. The method may include transmitting the two-dimensional encoded image to the mobile device.

Aspects of this disclosure relate to an apparatus which includes a processor and a memory storing computer executable instructions that, when executed by the processor, configure the apparatus to perform a method of transmitting funds to a mobile device. The method may include electronically receiving a request for funds, wherein said request identifies an addressable ID of a mobile device to which the data regarding the funds is to be transmitted and create a funds disbursement, including funds disbursement data. The method may include creating a funds disbursement which may include: deducting from an associated bank account an amount based on the requested funds; generating a one time credit card number associated with the predetermined amount of the funds deducted from the associated bank account and configuring the funds disbursement data including the one time credit card number and the name of the particular person to which the funds should be dispersed as a two-dimensional encoded image. The method may include transmitting an unpublished URL to the mobile device through which the user may retrieve the two-dimensional encoded image over a wireless data connection to the Internet.

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a diagram of a general-purpose digital computing environment in which certain aspects of the present invention may be implemented;

FIG. 2 is a block diagram which schematically shows the interactions between different parties during a transaction according to at least one aspect of the present invention;

FIG. 3 is a flowchart of an illustrative example of a method for making a payment at a point of sale according to at least one aspect of the present invention;

FIG. 4A shows a screen shot of an illustrative online financial account that may be used in accordance with at least one aspect of the present invention;

FIG. 4B shows an illustrative embodiment of a data matrix glyph that may be used in accordance with at least one aspect of the present invention;

FIGS. 4C-D show screen shots of an illustrative online financial account that may be used in accordance with at least one aspect of the present invention;

FIG. 5 shows an illustrative embodiment of a data matrix glyph displayed in a mobile device in accordance with at least one aspect of the present invention;

FIG. 6 is a block diagram which schematically shows the interactions between different parties during a transaction according to at least one aspect of the present invention; and

FIG. 7 is a flowchart of an illustrative example of a method for making a payment at a point of sale according to at least one aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made.

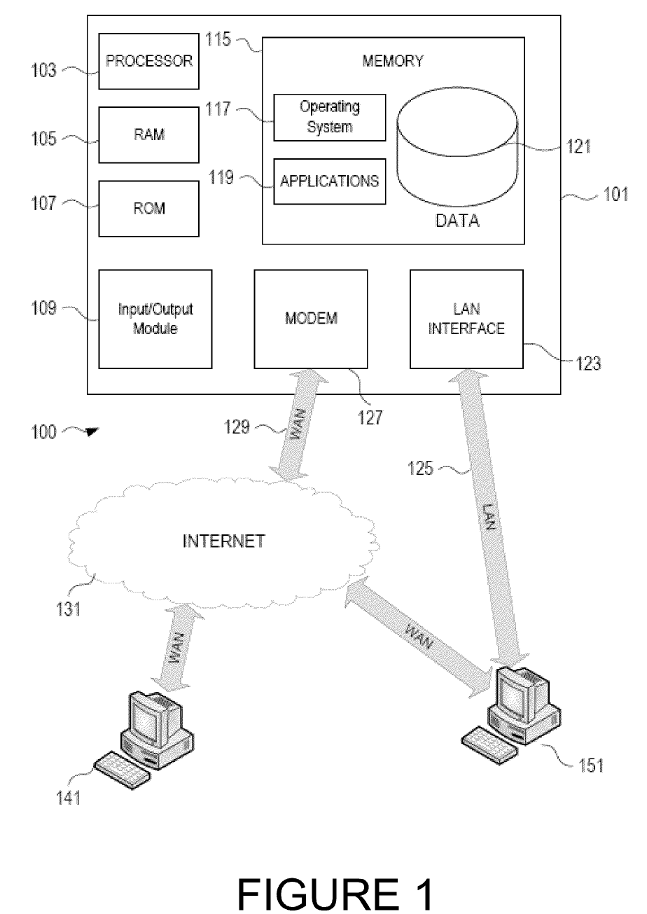

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. Neither should the computing system environment 100 be interpreted as having any dependency nor requirement relating to any one or combination of components illustrated in the exemplary computing system environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, the computing system environment 100 may include a computer 101 having a processor 103 for controlling overall operation of the computer 101 and its associated components, including RAM 105, ROM 107, input/output module 109, and memory 115. Computer 101 typically includes a variety of computer readable media. Computer readable media may be any available media that may be accessed by computer 101 and include both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 101. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. Although not shown, RAM 105 may include one or more are applications representing the application data stored in RAM memory 105 while the computer is on and corresponding software applications (e.g., software tasks), are running on the computer 101.

Input/output module 109 may include a microphone, keypad, touch screen, and/or stylus through which a user of computer 101 may provide input, and may also include one or more of a speaker for providing audio output and a video display device for providing textual, audiovisual and/or graphical output. Software may be stored within memory 115 and/or storage to provide instructions to processor 103 for enabling computer 101 to perform various functions. For example, memory 115 may store software used by the computer 101, such as an operating system 117, application programs 119, and an associated database 121. Alternatively, some or all of computer 101's computer executable instructions may be embodied in hardware or firmware (not shown). As described in detail below, the database 121 may provide centralized storage of account information and account holder information for the entire business, allowing interoperability between different elements of the business residing at different physical locations.

Computer 101 may operate in a networked environment supporting connections to one or more remote computers, such as branch terminals 141 and 151. The branch computers 141 and 151 may be personal computers or servers that include many or all of the elements described above relative to the computer 101. The network connections depicted in FIG. 1 include a local area network (LAN) 125 and a wide area network (WAN) 129, but may also include other networks. When used in a LAN networking environment, computer 101 is connected to the LAN 125 through a network interface or adapter 123. When used in a WAN networking environment, the server 101 may include a modem 127 or other means for establishing communications over the WAN 129, such as the Internet 131. It will be appreciated that the network connections shown are exemplary and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, an application program 119 used by the computer 101 according to an illustrative embodiment of the invention may include computer executable instructions for invoking user functionality related to communication, such as email, short message service (SMS), and voice input and speech recognition applications.

Terminals 141 or 151 may also be mobile terminals including various other components, such as a battery, speaker, and antennas (not shown). Input/output module 109 may include a user interface including such physical components as a voice interface, one or more arrow keys, joystick, data glove, mouse, roller ball, touch screen, or the like.

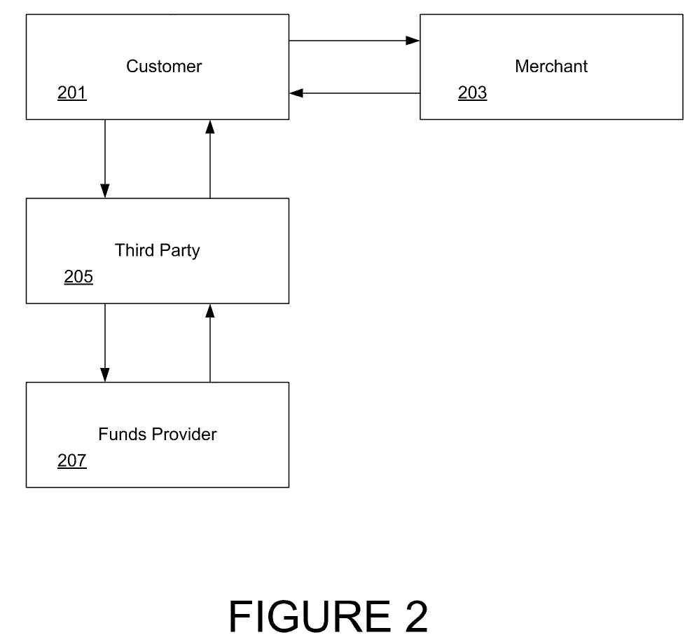

FIG. 2 is a block diagram which illustrates aspects of the present system and method for making payments via a mobile device. Specifically, the block diagram schematically shows the interactions between different parties during a transaction involving a payment made via a mobile device according to at least one aspect of the present invention. As seen in FIG. 2, such a transaction may involve a customer 201, a merchant 203, a third party 205 and a funds provider 207 (e.g., a financial institution, such as bank or other entity that can provide funds).

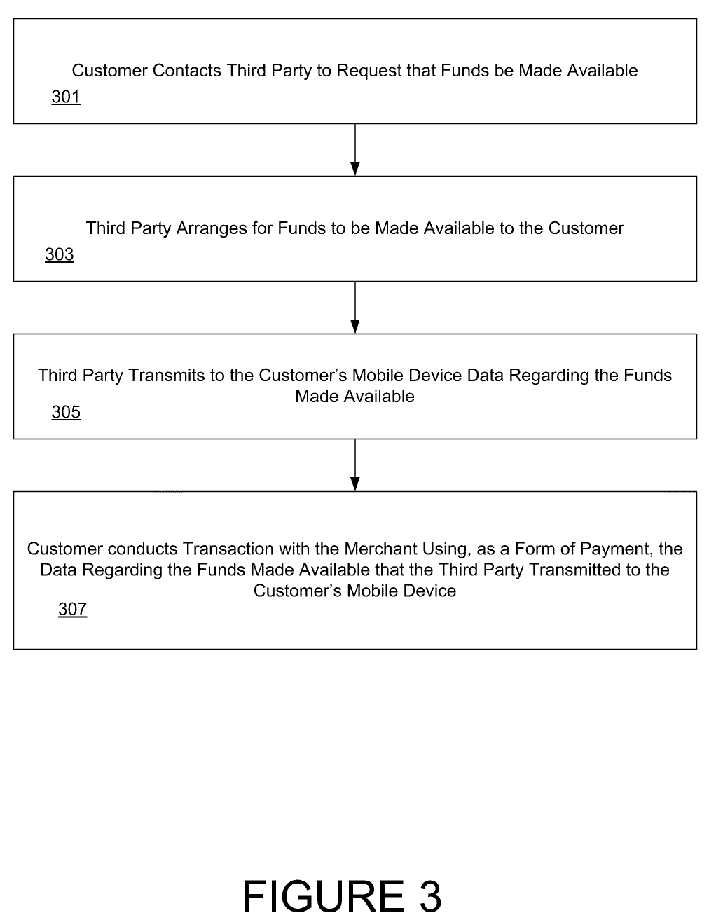

FIG. 3 illustrates a flow chart which demonstrates illustrative aspects of the present system and method for making payments via a mobile device. In accordance with one or more aspects of the present invention, step 301 includes a customer 201 contacting a third party 205 to request funds be made available in order to make a payment during a transaction. Step 303 includes the third party 205 arranging for the funds to be made available to the customer 201. Step 305 includes the third party 205 transmitting to the customer's mobile device data regarding the funds made available. Step 307 includes the customer 201 conducting the transaction with the merchant 203 using, as a form of payment, the data regarding the funds made available that the third party 205 transmits to the customer's mobile device.

According to particular aspects of this invention, and as will be described in detail below, the data regarding the funds made available that the third party transmits to the customer's mobile device can be in form of an image (such as a data matrix glyph, barcode, etc.). Alternatively, there might not be a third party involved in the transaction, but rather the customer him or herself might log on to a financial institution website and generate a payment from his or her own account.

The above described method can be further described by way of an example. According to one illustrative example in which the above method is used, a student (i.e., customer 201) is in a college bookstore (i.e., merchant 203) and is about to purchase a biology textbook for $200 at one of the store's registers. When the student attempts to pay for the textbook at the register with his credit card, it is declined. Therefore, the student calls his parents (i.e., third party 205) on his mobile device to ask for the $200 (i.e., step 301—customer contacts third party to request that funds be made available). The parents contact their bank (i.e., funds provider 207) to arrange for the $200 to be made available (i.e., step 303—third party arranges for funds to be made available to the customer), which the parents do as further described below.

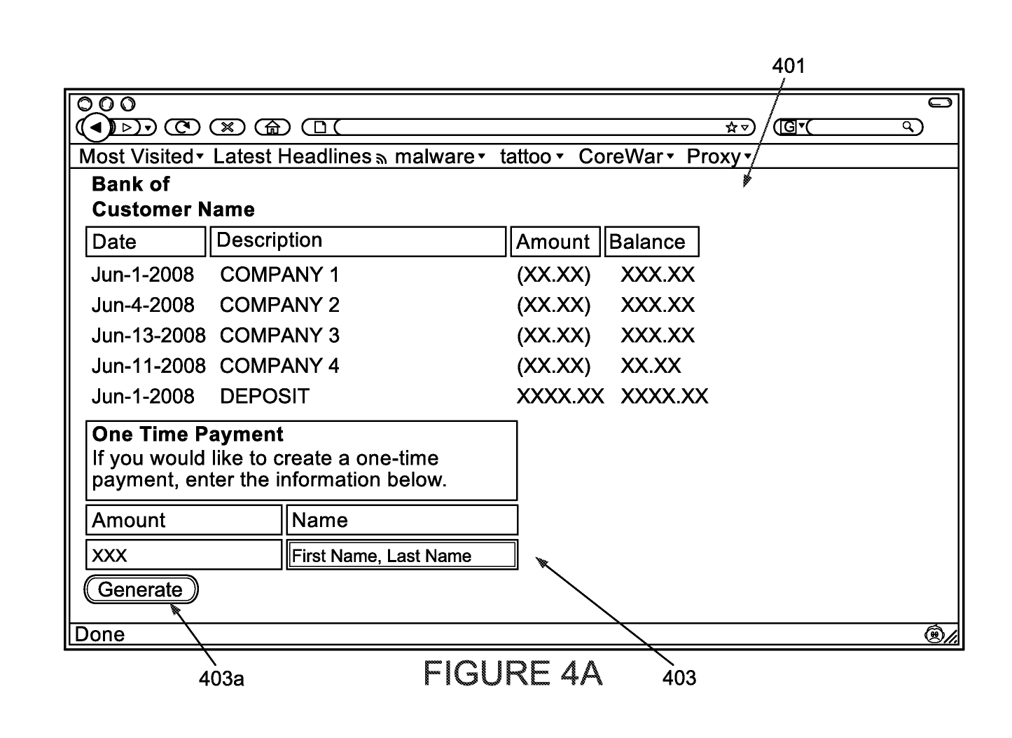

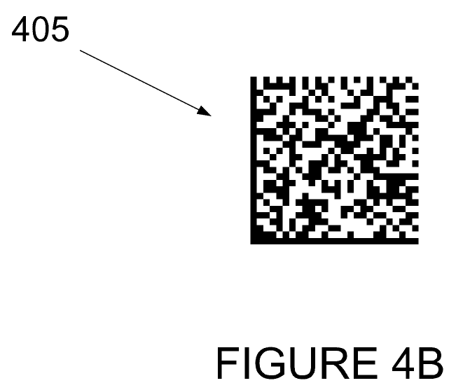

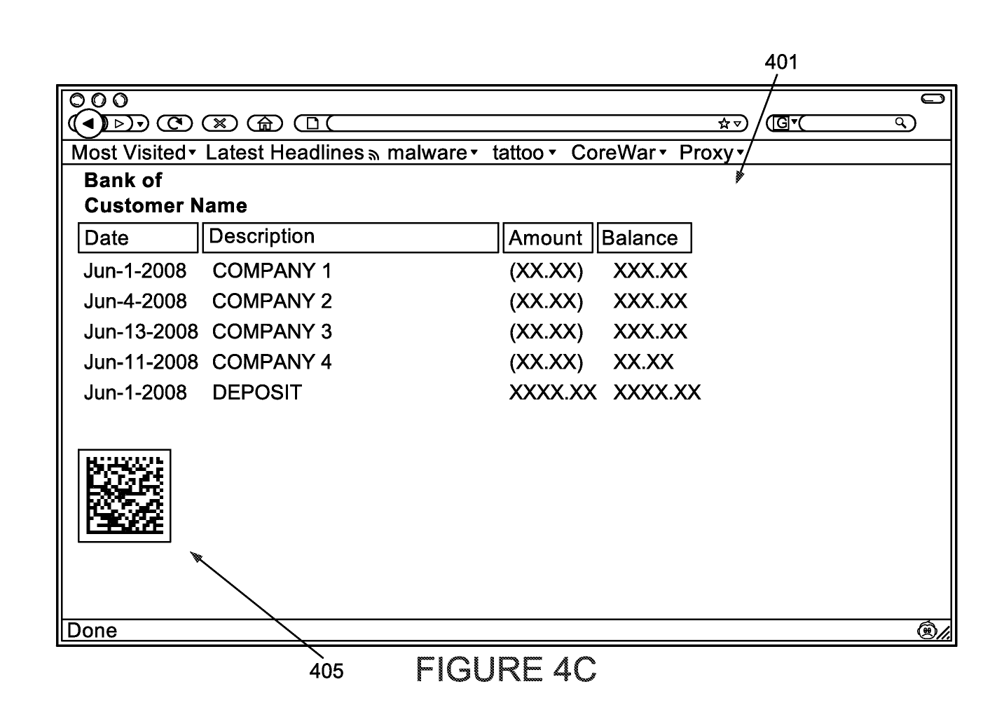

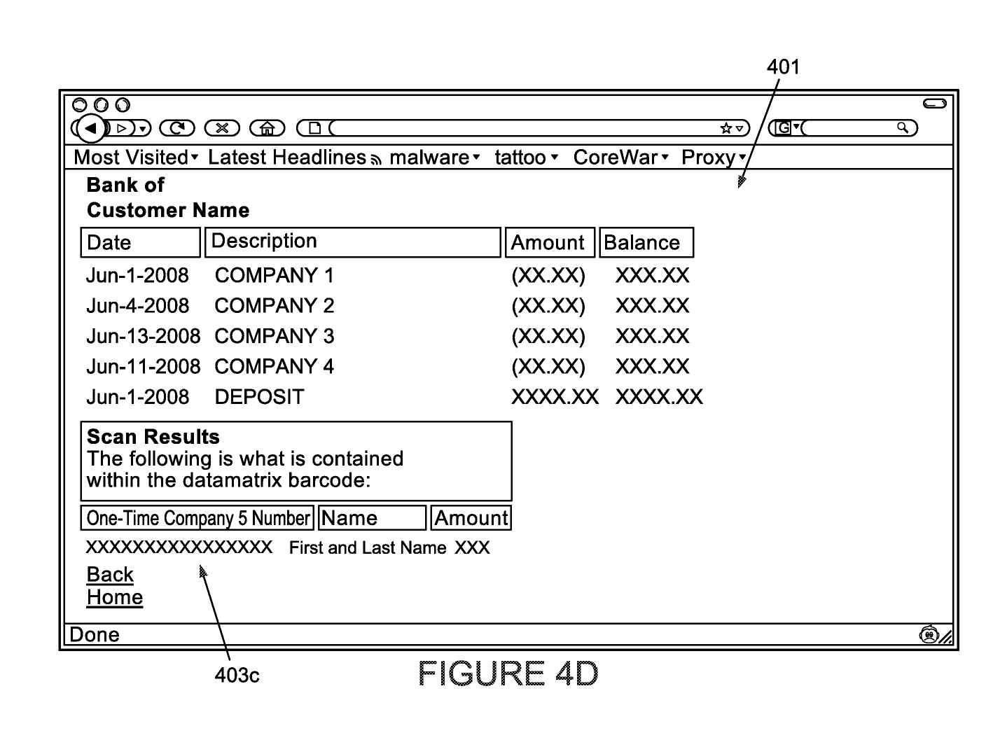

It is noted that according to one aspect of this embodiment, step 303 can be performed by accessing an online bank account to make the funds available. FIG. 4A shows an illustrative embodiment of a screen shot of such an online banking account 401 with a feature that allows such funds to be made available. As seen in FIG. 4A, the online banking account includes a section 403 for creating a funds disbursement to a particular person (or entity). This section 403 includes data fields for entering information about the funds disbursement, such as the amount of funds to be disbursed and the identity of the particular person to which the funds are to be disbursed (i.e., the particular person who is authorized to use the allocated funds, e.g., make a payment with the allocated funds). Section 403 may include one or more other data fields for additional, or alternative, information about the funds disbursement, such as additional personal information of the particular person to which the funds are to be disbursed (e.g., their phone number, an IP address, bank account routing information, etc.), a date or time at which the funds should be made available or by when the funds must be used, etc. Section 403 also includes a button 403a for generating the funds disbursement after all the relevant information has been entered. After the relevant information regarding the funds disbursement has been entered, the third party 205 can generate the funds disbursement by selecting button 403a.

According to some aspects, the funds provider 207 may have software and/or hardware capable of generating the funds disbursement, including generating data regarding the funds made available (i.e., funds disbursement data). For example, in the above example, when the “generate” button 403a is selected, the software can deduct from the bank account 401 an amount based on the requested funds disbursement. For example, the amount may be equal to the amount of requested funds. Further, the software and/or hardware can generate a one time credit card number which will be associated with the predetermined amount of the funds deducted from the bank account. Further, as mentioned above, according to some aspects of this invention, the funds disbursement data may be configured as an image. Therefore, the software and/or hardware can configure as an image, such data as the one time credit card number, the name of the particular person to which the funds should be dispersed, personal information of the particular person to which the funds are to be disbursed (e.g., their phone number, IP address, bank account routing information, etc.), a date or time at which the funds should be made available, or by when the funds must be used, etc. For example, the funds disbursement data may be configured as a barcode. Alternatively, the funds disbursement data may be configured as a data matrix glyph or other two-dimensional barcode or matrix.

A data matrix glyph is a two-dimensional (2D) barcode-like symbol that uses a small area of square modules with a unique pattern to encode symbols, characters, numbers, text, actual bytes of data, etc. A data matrix scanner (which operates similarly to a barcode scanner) can read the pattern to decode the symbols, characters, numbers, text, actual bytes of data, etc. A data matrix glyph is more efficient than a barcode, because it can hold a greater amount of data. Therefore, when encoding a large amount of data, such as the one time credit card number and other funds disbursement data, a data matrix glyph may be preferable to a barcode. An illustrative data matrix glyph 405 is shown in FIG. 4B.

FIG. 4C shows an illustrative embodiment of a screen shot of online bank account 401 described above after the funds disbursement has been generated. As can be seen, in section 403 the funds disbursement data has been configured as a data matrix glyph 405. In this example, the data matrix glyph 405 includes data relating to a one time credit card number that has been generated, the amount of funds that are available on the one time credit card number, the name of the particular person who is authorized to use the one time credit card number. For reference, FIG. 4D is provided, which is the same screen shot as 4C, except that it shows the same data contained in data matrix glyph 405, but in a form readable/understandable to the human eye.

It is noted, of course, that step 303 (i.e., arranging for the funds to be made available to the customer 201) could be performed by other methods as well. For example, the third party 205 may call the funds provider 207 via telephone to have the funds provider generate the funds disbursement data. Alternatively, step 303 could be performed by other electronic means.

In continuing with the above example of the student in the bookstore, once the parents have accessed the online banking account to make the funds available in the manner described above, the parent can transmit that data to the student's mobile device (i.e., step 305—the third party 205 transmitting to the customer's mobile device, data regarding the funds being made available). Specifically, according to at least one aspect of the invention, wherein the data regarding the funds made available (i.e., the funds disbursement data) has been configured as an image, the parents can transmit the image to the student's mobile device. For example, the parents can send an SMS message (e.g., a text message), MMS message (multimedia message), or an email which contains the data matrix glyph 405 to the student's cell phone. The funds provider will have software that allows the message, email, etc., (that contains the data matrix glyph 405) to be automatically created after the funds disbursement data is generated and then the third party can send the message directly to the intended recipient. Alternatively, the data matrix glyph could be electronically copied from the online account webpage and pasted into the message, email, etc. If sent via SMS, the text message might include an unpublished URL through which the user may retrieve the data matrix image over a wireless data connection to the Internet. This method could be used with emails or messages as well.

Once the student has received the message containing the funds disbursement data on their cell phone, the student can pay for the textbook using the funds disbursement (i.e., step 307—the customer 201 conducts the transaction with the merchant 203 using, as a form of payment, the data regarding the funds made available that the third party 205 transmitted to the customer's mobile device). Specifically, according to at least one aspect of this invention wherein the funds disbursement data has been configured as an image, the student can open the message containing the image and display the image for the bookstore merchant 203 to use as the payment. For example, when the funds disbursement data is configured as a data matrix glyph 405 and has been emailed or texted (SMS) to the student's cell phone or other mobile device, the student can use the mobile device to open the email or text message and display the data matrix glyph 405 on a screen (such as a LCD) of the mobile device.

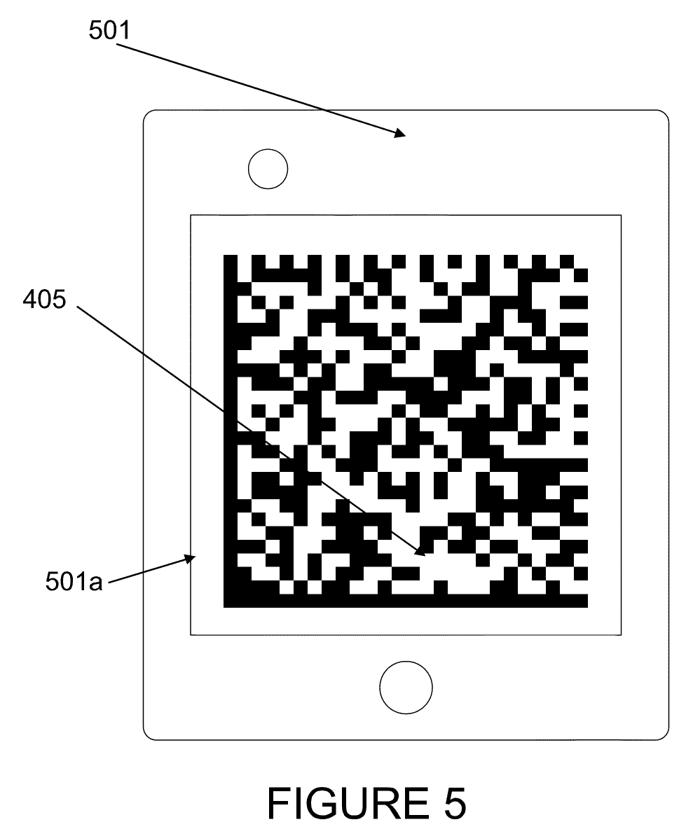

An illustrative example of such a data matrix glyph being displayed on the screen of an illustrative mobile device is shown in FIG. 5. As seen in FIG. 5, the mobile device 501 may include a screen 501a (such as a LCD). Further, as seen in FIG. 5, data matrix glyph 405 may be displayed on the screen 501a of the mobile device 501. As discussed above, the mobile device 501 could be a cell phone, smart phone, pager, PDA, etc. While not shown in the illustrative embodiment, according to aspects of the invention, the mobile device 501 could include a keyboard, exterior antenna, and other features conventional in such mobile devices.

Once the data matrix glyph 405 is displayed on the screen of the mobile device, the screen of the mobile device can be scanned by a data matrix reader (similar to a barcode reader) at the point of sale. In this example, the student can place the mobile device's screen (on which data matrix glyph 405 is displayed) under such a data matrix scanner that is connected to the bookstore's register. Thereby, the scanner will scan the data matrix glyph 405 and decode the data matrix glyph 405 to retrieve the funds disbursement data (e.g., the one time credit card number that has been generated, the amount of funds that are available on the one time credit card number, the name of the particular person who is authorized to use the one time credit card number) and upload funds disbursement data to the register.

The above described transaction between the student and the merchant is analogous to the student making the payment by “swiping” a gift card with a predetermined amount of money on it (e.g., $200) though a credit card reader. The gift card is registered with the student's name, so the student is authorized to use it and when the gift card is “swiped” through the card reader, the data is uploaded to the register. One advantage of the above described mobile device method, of course, is that the funds can be electronically delivered to the mobile device rather than in the “gift card” analogy wherein the gift card must be physically transferred.

Once the funds disbursement data has been uploaded to the register, the back end transaction of the merchant verifying the funds disbursement data can be done in conventional fashion. In other words, the merchant can proceed just as it would if a credit card number had been inputted manually by the clerk, “swiped” through a card reader by the user, etc.

Of course the above example is merely illustrative and many variations could be implemented without departing from the spirit of the invention. For example, according to some aspects of the invention, instead of the funds provider 207 being a financial institution and the method of making the funds available including accessing a bank account of the financial institution, the funds provider 207 may be a telecommunications carrier, e.g., a POTS carrier or a VOIP carrier. For example, the very telecommunications carrier through which the student placed the phone call to the parents could be the funds provider 207. In this case, the telecommunications carrier will already have some type of financial account set up with the parents through which the parents pay their monthly bill (e.g., a credit card number, direct debit arrangement with the parents bank account, etc,). The telecommunications carrier would have software and/or hardware which allows the parents to transmit the funds disbursement data to the student's cell phone by merely entering a touchtone menu and executing a series of touchtone signals. For example, the parents could hit “*9” (or some other touchtone signal to demonstrate to the telecommunication carrier's automated system that they would like to access this payment system) to place the student on hold and enter a touchtone payment system menu. The telecommunications carrier's software may provide touchtone menu prompts to allow the parents to enter: (1) a predetermined amount of funds that the parents would like billed to their monthly statement (e.g., the additional $200); (2) a phone number of the person to which they would like the funds sent (if the recipient is other than the person with whom they are on the phone); (3) an authorization code (e.g., a personal identification number [PIN]), etc. Once the information has been entered via the touch tone system, the software and/or hardware may verify the account information and, upon verification, transmit the funds disbursement data to the student's cell phone. Then the transaction may continue as described above.

As demonstrated by the above example, the funds provider 207 does not have to be a bank. Instead, the funds provider 207 may be any entity with the requisite account information and the requisite software and/or hardware to generate and transmit the funds disbursement data. For example, credit card companies, department stores, etc. may all be a funds provider 207 if the above requirements are met.

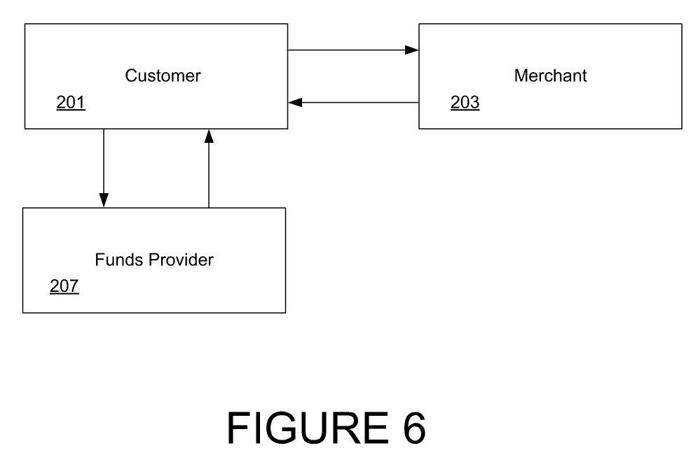

According to some aspects of this invention, no third party 205 is needed and, instead, the customer may contact the funds provider 207 directly. FIG. 6 is a block diagram which illustrates such aspects of the present system and method. Specifically, the block diagram schematically shows the interactions between different parties during such a transaction according to at least one aspect of the present invention. As seen in FIG. 6, such a transaction may involve a customer 201, a merchant 203, and a funds provider 207.

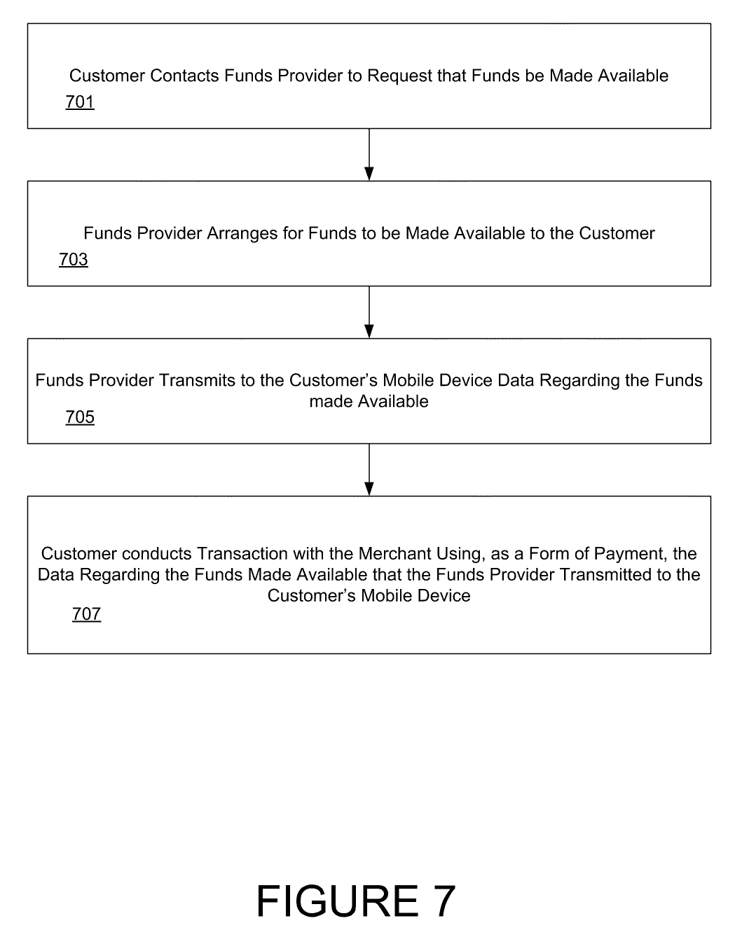

FIG. 7 illustrates a flow chart which demonstrates illustrative aspects of such a transaction. In accordance with one or more aspects of the present invention, step 701 includes a customer 201 contacting a funds provider 207 directly to request funds be made available in order to make a payment during a transaction. Step 703 includes the funds provider 207 arranging for the funds to be made available to the customer 201. Step 705 includes the funds provider 207 transmitting to the customer's mobile device data regarding the funds being made available. Step 707 includes the customer 201 conducting the transaction with the merchant 203 using, as a form of payment, the data regarding the funds being made available that the funds provider 207 transmits to the customer's mobile device.

In order to further describe the process it may be helpful to return to the above described example, wherein the student is in the bookstore. The process is similar to the process described with regard to FIGS. 2 and 3, but instead of contacting the parents, the student may contact the student's own bank directly. For example, the student may call the bank and have one of the bank's employees generate the funds disbursement data at the bank (through one of the bank's computers) in the manner described above and transmit it to the student's mobile device in the manner described above (e.g., SMS or email). Alternatively, according to some aspects of this invention, wherein the mobile device has Internet capabilities (e.g., a smart phone, PDA, etc.), the student could access his or her own online bank account directly via the mobile device and generate the funds disbursement data. Then the student could direct the funds disbursement data to be transmitted to the student's mobile device in the manner described above (e.g., SMS or email).

It is noted, that while the funds disbursement data in the above example included a one time credit card number for a predetermined amount of funding, in the present invention, funds disbursement data is not limited to such one time payment embodiments. Instead, according to some aspects of the present system and method, the funds disbursement data may include the customer's or third party's “regular” credit card number, account number, etc. The term “regular” is meant to imply the account is used regularly over a prolonged period of time (e.g., a customer would receive monthly statements, etc.). In this case, instead of the one time credit card number being generated, the “regular” credit card number, account number, etc. could be employed and transmitted by the system. Therefore, while the one time payment credit card number provides some measure of security in that, if it is compromised, only a certain amount of funding may be lost, the present system and method clearly allow for other “regular” accounts, credit cards to be used.

Regardless of whether a one time or “regular” account, credit card, etc. number is used, the present system and method can include a plurality of security features to prevent the sensitive information that is included in the funds disbursement data from being compromised. For example, presenting the funds disbursement data as an image (e.g., a bar code or data matrix glyph) prevents the sensitive information from being readable to human eye. Therefore, security for the funds disbursement data is increased. Further, it is worth noting that in this format wherein the funds disbursement data is able to be scanned, the entry of the data is quicker and less prone to error when compared to manual entry of the data. Also, it is noted that while barcode and data matrix glyphs have been discussed in detail, other formats for the funds disbursement data could be used as well. As long the format of the funds disbursement data is such that it is able to be communicated at the point of sale, it is within the scope of the invention.

Additional security measures could include transmitting an image of the customer embedded in, or along with, the funds disbursement data. Therefore, upon the funds disbursement data being uploaded at the point of sale, the merchant could verify if the customer using the funds disbursement data and the picture associated with the authorized user of funds disbursement data, in fact, match. Of course other security measures could be implemented as well. For example, entering a password or PIN to unlock the message or email. Additionally, or alternatively, requiring a password or PIN (which the customer already knows and has already been associated with the funds provider and that is separate from the fund disbursement data (e.g., a mother's maiden name, or a high school mascot)) be entered into the merchant's register after the data matrix glyph has been scanned in, in order for the transaction to be processed.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the features of the aforementioned illustrative examples may be utilized alone or in combination or subcombination with elements of the other examples. It will also be appreciated and understood that modifications may be made without departing from the true spirit and scope of the present invention. The description is thus to be regarded as illustrative instead of restrictive on the present invention.

1. A computer assisted method comprising:
electronically receiving a request for funds, wherein said request identifies an addressable ID of a mobile device to which the data regarding the funds is to be transmitted;
creating a funds disbursement, including funds disbursement data, wherein the step of creating a funds disbursement includes
deducting from an associated bank account an amount based on the requested funds,
generating a one time credit card number associated with the predetermined amount of the funds deducted from the associated bank account,
configuring the funds disbursement data including the one time credit card number, and the name of the particular person to which the funds should be dispersed as a two-dimensional encoded image;
transmitting the two-dimensional encoded image to the mobile device.

2. The method of claim 1, wherein the addressable ID is one or an IP address and a telephone number of the mobile device.

3. The method of claim 1, wherein the two-dimensional encoded image comprises a data matrix glyph.

4. The method of claim 1, wherein the funds disbursement data includes the amount of funds available on the one time credit card number.

5. The method of claim 1, wherein the funds disbursement data includes a date or time at which the funds should be made available, or by when the funds must be used.

6. The method of claim 1, wherein transmitting the two-dimensional encoded image to the mobile device, includes sending an email, SMS or MMS which includes the two-dimensional encoded image.

7. The method of claim 1, wherein the request for funds originates from the mobile device to which the data regarding the funds is to be transmitted.

8. An apparatus comprising:
a processor; and
a memory storing computer executable instructions that, when executed by the processor, configure the apparatus to perform a method of transmitting funds to a mobile device, said method comprising:
electronically receiving a request for funds, wherein said request identifies an addressable ID of a mobile device to which the data regarding the funds is to be transmitted,
creating a funds disbursement, including funds disbursement data, wherein the step of creating a funds disbursement includes
deducting from an associated bank account an amount based on the requested funds,
generating a one time credit card number associated with the predetermined amount of the funds deducted from the associated bank account,
configuring the funds disbursement data including the one time credit card number and the name of the particular person to which the funds should be dispersed as a two-dimensional encoded image, and
transmitting the two-dimensional encoded image to the mobile device.

9. The apparatus of claim 8, wherein the addressable ID is one or an IP address and a telephone number of the mobile device.

10. The apparatus of claim 8, wherein the two-dimensional encoded image comprises a data matrix glyph.

11. The apparatus of claim 8, wherein the funds disbursement data includes the amount of funds available on the one time credit card number.

12. The apparatus of claim 8, wherein the funds disbursement data includes a date or time at which the funds should be made available, or by when the funds must be used.

13. The apparatus of claim 8, wherein transmitting the two-dimensional encoded image to the mobile device, includes transmitting an email, SMS or MMS which includes the two-dimensional encoded image.

14. The apparatus of claim 8, wherein the request for funds originates from the mobile device to which the data regarding the funds is to be transmitted.

15. An apparatus comprising:
a processor; and
a memory storing computer executable instructions that, when executed by the processor, configure the apparatus to perform a method of transmitting funds to a mobile device, said method comprising:
electronically receiving a request for funds, wherein said request identifies an addressable ID of a mobile device to which the data regarding the funds is to be transmitted,
creating a funds disbursement, including funds disbursement data, wherein the step of creating a funds disbursement includes
deducting from an associated bank account an amount based on the requested funds,
generating a one time credit card number associated with the predetermined amount of the funds deducted from the associated bank account,
configuring the funds disbursement data including the one time credit card number and the name of the particular person to which the funds should be dispersed as a two-dimensional encoded image, and
transmitting an unpublished URL to the mobile device through which the user may retrieve the two-dimensional encoded image over a wireless data connection to the Internet.

16. The apparatus of claim 15, wherein the addressable ID is one or an IP address and a telephone number of the mobile device.

17. The apparatus of claim 15, wherein the two-dimensional encoded image comprises a data matrix glyph.

18. The apparatus of claim 15, wherein the funds disbursement data includes the amount of funds available on the one time credit card number.

19. The apparatus of claim 15, wherein transmitting the two-dimensional encoded image to the mobile device, includes transmitting an email, SMS or MMS which includes the two-dimensional encoded image.

20. The apparatus of claim 15, wherein the request for funds originates from the mobile device to which the data regarding the funds is to be transmitted.
